(19) United States
(12) Patent Application Publication
(10) Pub. No.: US 2025/0137606 A1
(43) Pub. Date: May 1, 2025

(54) COVER WINDOW AND MANUFACTURING METHOD FOR THE SAME

(71) Applicant: SEOYON E-HWA CO, LTD., Anyang (KR)

(72) Inventors: Si Wook LEE, Seoul (KR); Tae Woo KIM, Seoul (KR); Ho Jung KIM, Yangpyeong-gun (KR)

(21) Appl. No.: 18/932,573

(22) Filed: Oct. 30, 2024

(30) Foreign Application Priority Data
Oct. 31, 2023 (KR) 10-2023-0147647

(51) Int. Cl. F21S 41/20; B29C 45/00; B29C 45/14; B29K 69/00; B29K 105/00; B29L 9/00; B29L 11/00; F21S 43/20

(52) U.S. Cl. CPC F21S 41/285; B29C 45/0001; B29C 45/14811; F21S 43/265; F21S 43/28131; F21S 43/2817; B29K 2069/00; B29K 2105/0032; B29K 2105/0044; B29L 2009/005; B29L 2011/00

(57) ABSTRACT

Disclosed is a cover window using a plastic rather than a glass, and a method for manufacturing the same. The cover window includes: a base material layer formed of a transparent plastic material; a black layer stacked on one surface of the base material layer and formed along a periphery of the base material layer; and an elastomer layer formed to surround another surface of the base material layer and one surface of the black layer.

### CROSS REFERENCE TO RELATED APPLICATION

The present application claims priority to Korea Patent Application No. 10-2023-0147647, filed Oct. 31, 2023, the entire contents of which is incorporated herein for all purposes by this reference.

### FIELD

The present disclosure relates to a cover window, and a method for manufacturing the same, more particularly, to a cover window formed of a plastic rather than a glass, and to which an elastomer layer, which is a rubber molding, is applied so as to improve adhesion, and a method for manufacturing the same.

### BACKGROUND

Transparent exterior components of a vehicle are used more for lamps such as a headlamp, a brake lamp, and the like, and for outer-most covers of the lamps, polycarbonate (PC) is used for the headlamp, and polymethyl methacrylate (PMMA) is used for the brake lamp.

Polycarbonate (PC) is used for the headlamp, and polymethyl methacrylate (PMMA) is used for the rear lamp, however, the PMMA is very fragile, and cannot be used for the head lamp due to a stability reason, and the PC has poor weatherability and therefore, the PC is supplemented through hard coating.

A black region of a vehicle window using double injection of the headlamp is extremely small which is about 3 mm to 4 mm, however, problems occur such as yellowing and the like due to sunlight by exposure to the outside in a large area and detach of a coated surface.

When the transparent PC layer is exposed to the sunlight or an artificial light, bonding of polymers may be broken by the ultraviolet rays. That may lead to broken bonding of polymers, chalking, discoloration (yellowing), and physical property deterioration. In order to minimize influence of deterioration of adhesion in a boundary surface, a deteriorated life expectancy of the coated layer, or yellowing when performing the dual injection in a large area, an excellent resin composition capable of shielding of the visible rays, and improving transmittance and refractive index for the infrared rays is needed.

Meanwhile, a problem of adhesion does not matter when conducting molding and injection molding the PC and a thermoplastic elastomer, hereinafter referred to as a TPE, however, a strict quality standard is applied in terms of characteristics of exterior components of a vehicle.

When conducting insert injection of the PC and the TPE, the adhesion may deteriorate because of a temperature of a base material, a temperature of a mold, a temperature of a resin, and an injection pressure. When applying intaglio in order to improve such a problem, for the purpose of increasing a surface area of the injection surface, there is a problem that the sticking force of the PC and the TPE deteriorates due to the gas. That is, the adhesion deteriorates as molding may not be performed or the surface quality deteriorates because the gas is filled in the recessed portion.

### PRIOR ART LITERATURE

### Patent Literature

(Patent Literature 1) Korea Patent No. 10-2325187 (Nov. 5, 2021)

### SUMMARY

The present disclosure is conceived to solve the above-described problems, and an object of the present disclosure is to provide a cover window formed of a plastic rather than a glass, and to which an elastomer layer, which is a rubber molding, is applied, thereby improving adhesion, and a method for manufacturing the same.

Further, an object of the present disclosure is to provide a cover window capable of improving light stability and preventing deterioration of adhesion by being formed of a plastic, rather than a glass, and a method for manufacturing the same.

Moreover, an object of the present disclosure is to provide a cover window capable of improving a problem of intrusion into a boundary surface by forming a notch on the boundary surface between the base material layer and the black layer, and a method for manufacturing the same.

One embodiment is a cover window, including: a base material layer formed of a transparent plastic material; a black layer stacked on one surface of the base material layer and formed along a periphery of the base material layer; and an elastomer layer formed to surround another surface of the base material layer and one surface of the black layer.

In addition, in the black layer, a protrusion protruding based on one surface of the black layer and coupled to the elastomer layer such that the protrusion is inserted into the elastomer layer may be formed.

In addition, the black layer may be stacked on the base material layer by dual injection or insert injection, and a molding protrusion may be formed in an injection mold at a corresponding position on a boundary surface between the base material layer and the black layer, inside the base material layer.

In addition, a notch corresponding to a shape of the molding protrusion may be formed in the base material layer.

In addition, the notch may be formed to have a thickness which is 5% to 10% of a thickness of the black layer.

In addition, the base material layer may include 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, and 0.1 to 5 wt.-% of a solvent used for a coating material.

In addition, the black layer may include 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, 0.1 to 5 wt.-% of a solvent used for a coating material, and 0.0001 to 5 wt.-% of a light shielding agent.

In addition, the cover window may further include: a coating layer stacked on another surface of the base material layer, and the elastomer layer may be formed to surround the black layer, the base material layer, and the coating layer.

In addition, the coating layer may include 30 to 50 wt.-% of a polyhedral oligomeric silsesquioxane (POSS), 20 to 30 wt.-% of an epoxy-based oligomer, 10 to 20 wt.-% of an epoxy-based monomer, 5 to 30 wt.-% of nano-silica, 5 to 10 wt.-% of a silicon oil, 1 to 5 wt.-% of a metal oxide, 1 to 3 wt.-% of an ultraviolet absorber, 1 to 3 wt.-% of an ultraviolet scattering agent, 1 to 5 wt.-% of a light stabilizer, and 1 to 5 wt.-% of other additives.

Another embodiment is a method for manufacturing a cover window, including: forming a base material layer formed of a transparent plastic material; forming a black layer on one surface of the base material layer along a periphery of the base material layer; and forming an elastomer layer to surround another surface of the base material layer and one surface of the black layer.

In addition, in the forming a black layer, a protrusion protruding based on one surface of the black layer and coupled to the elastomer layer such that the protrusion is inserted into the elastomer layer may be formed in the black layer.

In addition, in the forming a black layer, the black layer may be stacked on the base material layer by dual injection or insert injection, and a molding protrusion may be formed in an injection mold at a corresponding position on a boundary surface between the base material layer and the black layer, inside the base material layer.

In addition, in the forming a black layer, a notch corresponding to a shape of the molding protrusion may be formed in the base material layer.

In addition, the notch may be formed to have a thickness which is 5% to 10% of a thickness of the black layer.

In addition, in the forming a base material layer, the base material layer may include 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, and 0.1 to 5 wt.-% of a solvent used for a coating material.

In addition, in the forming a black layer, the black layer may include 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, 0.1 to 5 wt.-% of a solvent used for a coating material, and 0.0001 to 5 wt.-% of a light shielding agent.

In addition, the method may further include: forming a coating layer on another surface of the base material layer after the forming a black layer, and the elastomer layer may be formed to surround the black layer, the base material layer, and the coating layer.

In addition, in the forming a coating layer, the coating layer may include 30 to 50 wt.-% of a polyhedral oligomeric silsesquioxane (POSS), 20 to 30 wt.-% of an epoxy-based oligomer, 10 to 20 wt.-% of an epoxy-based monomer, 5 to 30 wt.-% of nano-silica, 5 to 10 wt.-% of a silicon oil, 1 to 5 wt.-% of a metal oxide, 1 to 3 wt.-% of an ultraviolet absorber, 1 to 3 wt.-% of an ultraviolet scattering agent, 1 to 5 wt.-% of a light stabilizer, and 1 to 5 wt.-% of other additives.

According to a cover window and a method for manufacturing the same according to the present disclosure, there is an effect of improving an adhesion strength of the cover window because adhesion between the PC and the TPE increases.

In addition, there are effects of reducing manufacturing costs, preventing a safety accident that may occur due to breakage by using a plastic rather than a glass, and preventing deterioration of adhesion and discoloration on a boundary surface between the base material layer and the black layer when dual injection is conducted.

Further, according to the present disclosure, there is an effect of preventing breakage of the base material layer and the coating layer and discoloration of the coating layer.

### BRIEF DESCRIPTION OF THE DRAWINGS

FIG. 1 is a cross-sectional view schematically illustrating a cover window according to an embodiment of the present disclosure.

FIG. 2 is a view illustrating a protrusion of a cover window according to an embodiment of the present disclosure and a flow path of an injected resin.

FIG. 3 is a cross-sectional view schematically illustrating a cover window including a coating layer according to an embodiment of the present disclosure.

FIG. 4 is a cross-sectional view schematically illustrating a cover window according to an embodiment of the present disclosure and is a view illustrating a transfer phenomenon of ultraviolet rays (a), visible rays (b) and infrared rays (c).

FIG. 5 is a cross-sectional view schematically illustrating a notch of a cover window according to an embodiment of the present disclosure.

FIG. 6 is a view schematically illustrating a molding protrusion of an injection mold for forming a black layer on a cover window according to an embodiment of the present disclosure.

FIG. 7 is a flowchart schematically illustrating a method for manufacturing a cover window according to an embodiment of the present disclosure.

### DETAILED DESCRIPTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

The terms used in the present specification are merely used to describe specific embodiments and are not intended to limit the present invention. A singular expression includes a plural expression unless a description to the contrary is specifically pointed out in context.

Although not defined otherwise, all terms including technical terms and scientific terms used herein have the same meanings as those generally understood by a person having ordinary knowledge in the art to which the present invention pertains. Terms defined in a dictionary generally used are additionally interpreted as having a meaning consistent with the related art documents and contents currently disclosed, and unless defined otherwise, are not interpreted as having an ideal or very official meaning.

Hereinafter, an embodiment of the present disclosure in more detail is explained by referring to accompanying drawings.

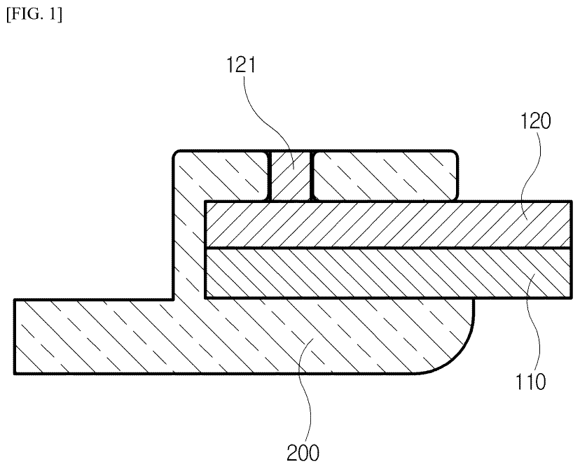

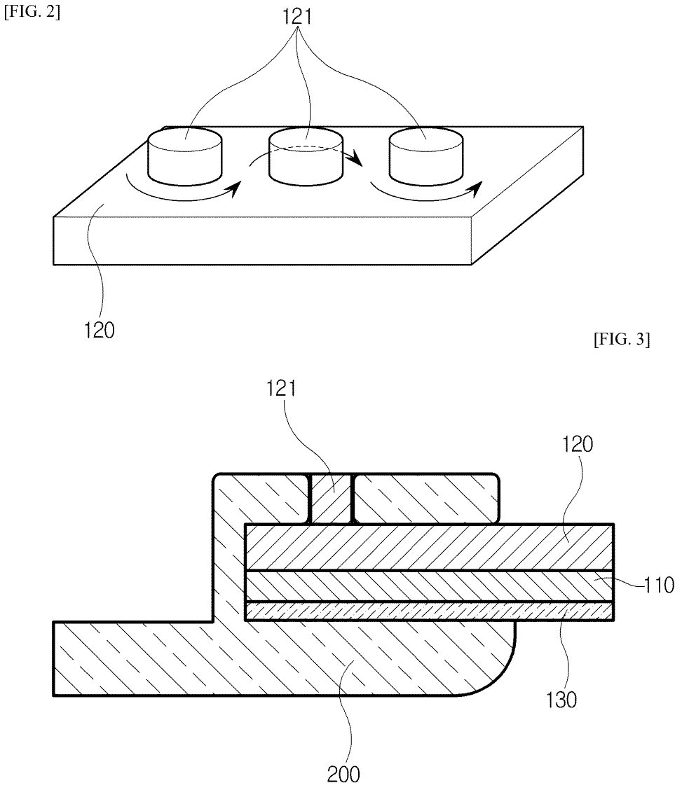

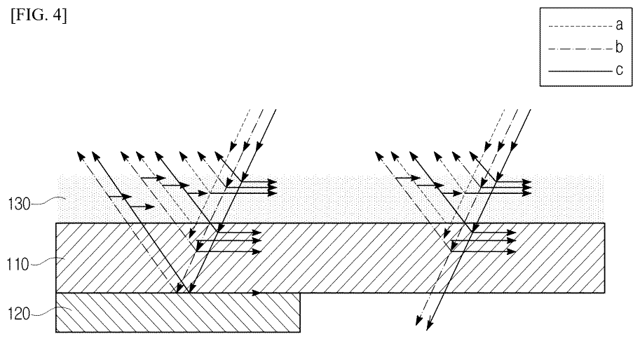

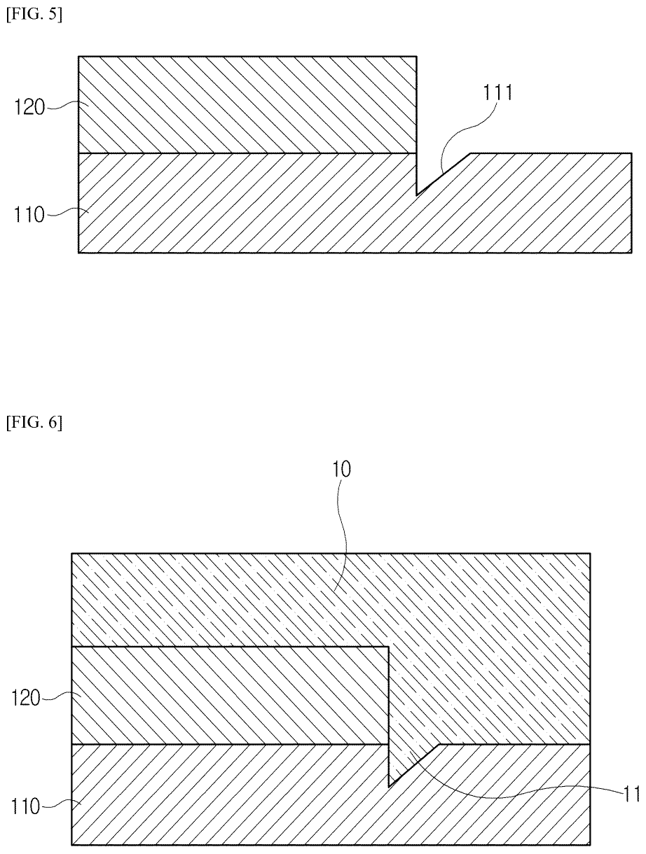

FIG. 1 is a cross-sectional view schematically illustrating a cover window according to an embodiment of the present disclosure, FIG. 2 is a view illustrating a protrusion of a cover window according to an embodiment of the present disclosure and a flow path of an injected resin, FIG. 3 is a cross-sectional view schematically illustrating a cover window including a coating layer according to an embodiment of the present disclosure, FIG. 4 is a cross-sectional view schematically illustrating a cover window according to an embodiment of the present disclosure and is a view illustrating a transfer phenomenon of ultraviolet rays (a), visible rays (b) and infrared rays (c), FIG. 5 is a cross-sectional view schematically illustrating a notch of a cover window according to an embodiment of the present disclosure, and FIG. 6 is a view schematically illustrating a molding protrusion of an injection mold for forming a black layer on a cover window according to an embodiment of the present disclosure.

Referring to FIGS. 1 to 6, a cover window according to an embodiment of the present disclosure includes a base material layer 110 formed of a transparent plastic material; a black layer 120 stacked on one surface of the base material layer 110; and an elastomer layer 200 formed to surround another surface of the base material layer 110 and one surface of the black layer 120.

The cover window according to the present disclosure may replace glasses of a vehicle, and may be used for transparent exterior components of a vehicle such as a headlamp, and a brake lamp. In addition, a shape of the cover window may vary according to a shape of a position to which the cover window is applied in a vehicle. That is, the shape of the cover window may vary in a wide variety.

Here, the base material layer 110 may be formed of at least one among PMMA (polymethyl methacrylate), PC (polycarbonate), PET (polyethylene terephthalate), PEN (poly ethylene naphthalate), and CPI (colorless polyimide).

The base material layer 110 may be manufactured in a sheet shape by extruding the above-mentioned material so as to ensure no problems such as deformation, birefringence, formability (film bursting, elongation shortage) and the like. In addition, a specially colored PC material may be used for the base material layer 110 to reproduce a tinting color of a window glass.

In more detail, the base material layer 110 may be manufactured by including 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, and 0.1 to 5 wt.-% of a solvent used for a coating material.

Here, the colored pigments are particles of an organic component and absorb a great amount of oil, thereby becoming able to prevent deterioration of weatherability and anti-corrosiveness of a coating state. The colored pigments may have colors such as black, green, white, transparent colors and the like. As an example, the colored pigments of the base material layer 110 may have a transparent color.

The base material layer 110 includes the colored pigments and therefore, light transmission of the base material layer 110 may greatly decline under a condition of having a color. Accordingly, there is an effect that the base material layer 110 improves not only light safety issues such as yellowing and aging due to infrared rays, but also a surface temperature rise issue due to ultraviolet rays, and deterioration of adhesion and reduction of life expectancy of the coating surface resulting from the surface temperature rise.

A hindered amine light stabilizer (hereinafter referred to as “HALS”), which is an ultraviolet ray stabilizer, may serve to cease a photo-oxidation reaction by removing a free radical generated during a photolysis reaction. The base material layer 110 may block light from entering the inside of a polymeric material through the HALS, the light stabilizer, and the colored pigments. Due to such a light blocking effect, it is possible to minimize the influence of a harmful light wavelength band of 290 to 400 nm which causes photooxidized degradation.

The black layer 120 is formed along a periphery of the base material layer 110, and forms an edge portion of the cover window. A shape of the black layer 120 may vary according to a shape of the cover window.

The black layer 120 includes 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, 0.1 to 5 wt.-% of a solvent used for a coating material, and 0.0001 to 5 wt.-% of a light shielding agent.

As an embodiment, the colored pigments of the black layer 120 may have a black color. The black layer 120 includes the colored pigments and therefore, light transmission of the black layer 120 may greatly decline under a condition of having a color. Accordingly, there is an effect that the black layer 120 improves not only light safety issues such as yellowing and aging due to ultraviolet rays, but also a surface temperature rise issue due to infrared rays and deterioration of adhesion and reduction of life expectancy of the coating surface resulting from the surface temperature rise.

The black layer 120 may block light from entering the inside of a polymeric material through the HALS, the light stabilizer, and the colored pigments. Due to such a light blocking effect, it is possible to minimize the influence of a harmful light wavelength band of 290 to 400 nm which causes photooxidized degradation.

The black layer 120 includes 0.0001 to 5 wt.-% of the light shielding agent. Referring to FIG. 4, under a condition where only the base material layer 110 exists, the ultraviolet rays (a) are blocked, but visible rays (b) and the infrared rays (c) are transmitted. However, when stacking the black layer 120 on the base material layer 110, transmittance of the visible rays (b) and the infrared rays (c) decrease, thereby the effect of blocking light may increase.

The elastomer layer 200 is formed to surround another surface of the base material layer 110 and one surface of the black layer 120. The elastomer layer 200 may be a resin of elastomers such as a thermoplastic elastomer (TPE), or a thermo plastic vulcanizate (TPV).

In the black layer 120, a protrusion 121 protruding based on one surface of the black layer 120 and coupled to the elastomer layer 200 such that the protrusion 121 is inserted into the elastomer layer 200 is formed. The protrusion 121 may be formed in plural numbers on one surface of the black layer 120.

As an example, the elastomer layer 200 may be injection molded as the TPE resin flows between the plurality of protrusions 121. That is, when insert injecting the elastomer layer 200, the injection surface area increases due to a convex shape of the protrusions 121, thereby becoming able to increase the sticking intensity between the black layer 120 and the elastomer layer 200.

The black layer 120 is stacked on the base material layer 110 by dual injection or insert injection. A molding protrusion 11 is formed in an injection mold 10 at a corresponding position on a boundary surface between the base material layer 110 and the black layer 120, inside the base material layer 110.

A notch 111 corresponding to a shape of the molding protrusion 11 is formed in the base material layer 110. In more detail, the molding protrusion 11 is formed in the injection mold 10 on the boundary surface between the base material layer 110 and the black layer 120, and after the black layer 120 is injected, the notch 111 in a dug shape corresponding to a shape of the molding protrusion 11 is formed in the base material layer 110.

The notch 111 is formed so as to improve a problem of intrusion by the black layer 120 into the base material layer 110 due to generation of a tolerance on the boundary surface between the base material layer 110 and the black layer 120 when injecting the black layer 120 into the base material layer 110. In this case, when a dimension of the notch 111 on the boundary surface between the base material layer 110 and the black layer 120 is great, bending and flashing of the external appearance of the base material layer 110 occurs due to squashing, and a quality problem occurs on the boundary surface between the base material layer 110 and the black layer 120. Therefore, a suitable dimensioning of the notch 111, that is, the edge, on the boundary surface is necessary.

As an embodiment, the notch 111 may be formed to have a thickness which is 5% to 10% of a thickness of the black layer 120. When the thickness of the notch 111 is less than 5% of the thickness of the black layer 120, the effect of improving a problem of intrusion into the base material layer 110 is insufficient, and when the thickness of the notch 111 exceeds 10% thereof, the quality problem of leaving a mark on the base material layer 110 may occur.

The cover window according to the embodiment of the present disclosure further includes a coating layer 130 stacked on another surface of the base material layer 110. The coating layer 130 is formed on a surface of the base material layer 110 and serves to protect the base material layer 110. To this end, the coating layer 130 may use an organic-inorganic hybrid compound as a coating liquid to be applied thereto. At this instance, the elastomer layer 200 is formed to surround the black layer 120, the base material layer 110, and the coating layer 130.

In addition, the organic-inorganic hybrid compound may be formed by chemically bonding silica to an epoxy resin. Here, when a content of the silica increases, a hardness increases while flexibility decreases, and when a content of the epoxy resin increases, flexibility increases while the hardness decreases. Therefore, it is possible to adjust the contents of the epoxy resin and the silica in correspondence with purposes to which the organic-inorganic hybrid compound may be applied.

Here, the organic-inorganic hybrid compound may be formed by chemically bonding the epoxy resin and the silica to each other, rather than simply combining the epoxy resin and the silica with each other.

The mixture formed by simply combining the epoxy resin and the silica with each other has an advantage of easy manufacture, but has shortcomings such as poor transmittance, a low surface hardness, and poor light resistance, weatherability, and chemical resistance.

In comparison with the mixture, when chemically bonding the epoxy resin and the silica to each other, although the manufacture is difficult, it is possible to secure the transmittance to 89% or more, superior hardness and flexibility, superior light resistance, weatherability, and chemical resistance, and to have no scattering reflection and refraction.

Therefore, the cover window according to the embodiment of the present disclosure forms the coating layer 130 obtained by chemically bonding the epoxy resin and the silica to each other on its external surface as a coating.

The coating layer 130 includes 30 to 50 wt.-% of a polyhedral oligomeric silsesquioxane (POSS), 20 to 30 wt.-% of an epoxy-based oligomer, 10 to 20 wt.-% of an epoxy-based monomer, 5 to 30 wt.-% of nano-silica, 5 to 10 wt.-% of a silicon oil, 1 to 5 wt.-% of a metal oxide, 1 to 3 wt.-% of an ultraviolet absorber, 1 to 3 wt.-% of an ultraviolet scattering agent, 1 to 5 wt.-% of a light stabilizer, and 1 to 5 wt.-% of other additives.

For example, the coating layer 130 may be formed to have a thickness of 10 to 20 μm. To this end, the coating layer 130 may be formed to have a thickness of 10 to 20 μm by applying the coating liquid, which is the organic-inorganic hybrid compound, to the base material layer 110, flattening the coating liquid using a roller spaced apart at a 10 to 20 μm interval from a surface of the base material layer 110, and then, hardening the coating liquid.

In addition, the coating liquid may be hardened by emitting the ultraviolet rays of a wavelength band of 365 to 395 nm at a light amount of 500˜2000 mJ/cm².

The cover window according to the embodiment of the present disclosure is formed by stacking the coating layer 130 on another surface of the base material layer 110, therefore, the transmittance of the visible rays (b) is lowered from 88.5% to 59.2%, and a rate of blocking the infrared rays (c) is increased from 10% to 22%, thereby it is possible to improve physical properties such as the safety, weatherability, and wear resistance, thanks to light transmittance, as well as the effect of blocking light.

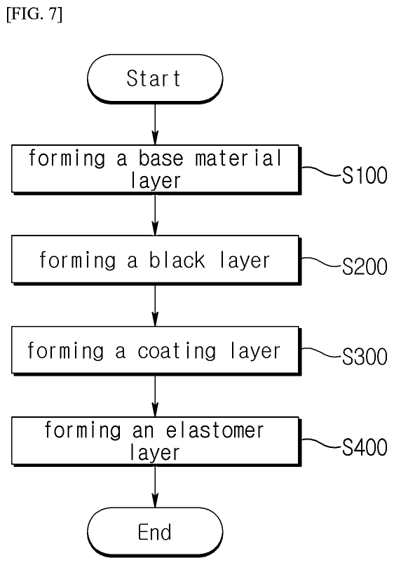

FIG. 7 is a flowchart schematically illustrating a method for manufacturing the cover window according to an embodiment of the present disclosure.

Referring to FIG. 7, the method for manufacturing the cover window according to an embodiment of the present disclosure includes forming a base material layer 110 formed of a transparent plastic material (S100); forming a black layer 120 on one surface of the base material layer 110 along a periphery of the base material layer 110 (S200); and forming an elastomer layer 200 to surround another surface of the base material layer 110 and one surface of the black layer 120 (S400).

In the operation of forming a base material layer (S100), the base material layer 110 includes 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, and 0.1 to 5 wt.-% of a solvent used for a coating material.

In the operation of forming a black layer (S200), the black layer 120 is stacked on the base material layer 110 by dual injection or insert injection. The operation of forming a black layer 120 (S200) is forming the black layer 120 along the periphery of the base material layer 110, which is, forming an edge portion of the cover window.

In the operation of forming a black layer (S200), the molding protrusion 11 is disposed in the injection mold 10 at a corresponding position on the boundary surface between the base material layer 110 and the black layer 120, inside the base material layer 110, and therefore, the notch 111 corresponding to a shape of the molding protrusion 11 is formed in the base material layer 110. At this instance, for example, the notch 111 may be formed to have a thickness which is 5% to 10% of the thickness of the black layer 120.

In the operation of forming a black layer (S200), when the black layer 120 is stacked on the base material layer 110 by the dual injection, the black layer 120, which is a secondary molded product, is subsequently injected and stacked on one surface of the base material layer 110, which is a primary molded product.

In the operation of forming a black layer 120 (S200), when the black layer 120 is stacked on the base material layer 110 by the insert injection, the black layer 120, which is the secondary molded product, is injected and stacked on one surface of the base material layer 110, which is the primary molded product, after the base material layer 110 is injected and sufficiently cooled. In this case, there may occur a problem in that when the primary molded product is injected into the injection mold 10 for the second injection, a shape of the primary molded product and a shape of the secondary injection mold 10 do not match. To solve this problem, when a thickness of the primary molded product is 2.5 to 4.5t, it is possible to preheat an oven of 120 to 150° C. to be at 100 to 120° C., seat the primary molded product on the secondary injection mold 10, and then, perform the insert injection. By doing so, it is possible to improve generation of surface scratches on the cover window and occurrence of flashing on the base material layer 110 and the black layer 120.

In the operation of forming a black layer 120 (S200), the black layer 120 includes 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, 0.1 to 5 wt.-% of a solvent used for a coating material, and 0.0001 to 5 wt.-% of a light shielding agent.

Meanwhile, in the operation of forming a black layer (S200), the protrusion 121 protruding based on one surface of the black layer 120 and coupled to the elastomer layer 200 such that the protrusion 121 is inserted into the elastomer layer 200 is formed in the black layer 120.

In the operation of forming an elastomer layer (S400), the elastomer layer 200 is formed to surround another surface of the base material layer 110 and one surface of the black layer 120. The elastomer layer 200 may be formed by the insert injection on a resultant on which the operation of forming a black layer (S200) is performed. As an example, the operation of forming an elastomer layer (S400) may be injection molding of the elastomer layer 200 as the TPE resin flows between the plurality of protrusions 121.

The method for manufacturing the cover window according to an embodiment of the present disclosure may further include: forming a coating layer 130 on another surface of the base material layer 110 (S300). After the operation of forming a black layer (S200) is performed, when the coating layer 130 is formed in the operation of forming a coating layer (S300), the operation of forming an elastomer layer (S400) may be performed such that the elastomer layer 200 surrounds the base material layer 110, the black layer 120, and the coating layer 130.

In the operation of forming a coating layer (S300), the coating layer 130 is formed by applying the organic-inorganic hybrid compound as a coating liquid to the base material layer 110. In the operation of forming a coating layer (S300), the base material layer 110 may be directly coated by applying the coating liquid directly to the base material layer 110, and then, flattening and hardening the coating liquid.

Here, the organic-inorganic hybrid compound formed by chemically bonding the silica to the epoxy resin is used as the coating liquid. Here, when a content of the silica increases, a hardness increases while flexibility decreases, and when a content of the epoxy resin increases, flexibility increases while the hardness decreases. Therefore, it is possible to adjust the contents of the epoxy resin and the silica in correspondence with purposes to which the organic-inorganic hybrid compound may be applied.

In addition, the coating liquid is flattened by using a roller or a steel plate such that the coating liquid applied to the base material layer 110 can have a constant thickness.

When hardening the coating liquid, the coating liquid may be hardened by emitting the ultraviolet rays thereto. In more detail, the hardening of the coating liquid may be done by emitting the ultraviolet rays of a wavelength band of 365 to 395 nm at a light amount of 500˜2000 mJ/cm².

Meanwhile, in the forming the coating layer (S300), the coating layer 130 includes 30 to 50 wt.-% of a polyhedral oligomeric silsesquioxane (POSS), 20 to 30 wt.-% of an epoxy-based oligomer, 10 to 20 wt.-% of an epoxy-based monomer, 5 to 30 wt.-% of nano-silica, 5 to 10 wt.-% of a silicon oil, 1 to 5 wt.-% of a metal oxide, 1 to 3 wt.-% of an ultraviolet absorber, 1 to 3 wt.-% of an ultraviolet scattering agent, 1 to 5 wt.-% of a light stabilizer, and 1 to 5 wt.-% of other additives.

While the present disclosure has been described with reference to the specific embodiments, the specific embodiments are only for specifically explaining the present disclosure, and the present disclosure is not limited to the specific embodiments. It is apparent that the present disclosure may be modified or altered by those skilled in the art without departing from the technical spirit of the present disclosure.

All the simple modifications or alterations to the present disclosure fall within the scope of the present disclosure, and the specific protection scope of the present disclosure will be defined by the appended claims.

REFERENCE NUMERALS

```
  10: injection mold
  11: molding protrusion
110: base material layer
111: notch
120: black layer
121: protrusion
130: coating layer
200: elastomer layer
```

What is claimed is:

1. A cover window, comprising:
a base material layer formed of a transparent plastic material;
a black layer stacked on one surface of the base material layer and formed along a periphery of the base material layer; and
an elastomer layer formed to surround another surface of the base material layer and one surface of the black layer.

2. The cover window of claim 1,
wherein in the black layer, a protrusion protruding based on one surface of the black layer and coupled to the elastomer layer such that the protrusion is inserted into the elastomer layer is formed.

3. The cover window of claim 1,
wherein the black layer is stacked on the base material layer by dual injection or insert injection, and
wherein a molding protrusion is formed in an injection mold at a corresponding position on a boundary surface between the base material layer and the black layer, inside the base material layer.

4. The cover window of claim 3,
wherein a notch corresponding to a shape of the molding protrusion is formed in the base material layer.

5. The cover window of claim 4,
wherein the notch is formed to have a thickness which is 5% to 10% of a thickness of the black layer.

6. The cover window of claim 1,
wherein the base material layer comprises 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, and 0.1 to 5 wt.-% of a solvent used for a coating material.

7. The cover window of claim 1,
wherein the black layer comprises 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, 0.1 to 5 wt.-% of a solvent used for a coating material, and 0.0001 to 5 wt.-% of a light shielding agent.

8. The cover window of claim 1, further comprising:
a coating layer stacked on another surface of the base material layer,
wherein the elastomer layer is formed to surround the black layer, the base material layer, and the coating layer.

9. The cover window of claim 8,
wherein the coating layer comprises 30 to 50 wt.-% of a polyhedral oligomeric silsesquioxane (POSS), 20 to 30 wt.-% of an epoxy-based oligomer, 10 to 20 wt.-% of an epoxy-based monomer, 5 to 30 wt.-% of nano-silica, 5 to 10 wt.-% of a silicon oil, 1 to 5 wt.-% of a metal oxide, 1 to 3 wt.-% of an ultraviolet absorber, 1 to 3 wt.-% of an ultraviolet scattering agent, 1 to 5 wt.-% of a light stabilizer, and 1 to 5 wt.-% of other additives.

10. A method for manufacturing a cover window, comprising:
forming a base material layer formed of a transparent plastic material;
forming a black layer on one surface of the base material layer along a periphery of the base material layer; and
forming an elastomer layer to surround another surface of the base material layer and one surface of the black layer.

11. The method of claim 10,
wherein in the forming a black layer, a protrusion protruding based on one surface of the black layer and coupled to the elastomer layer such that the protrusion is inserted into the elastomer layer is formed in the black layer.

12. The method of claim 10,
wherein in the forming a black layer, the black layer is stacked on the base material layer by dual injection or insert injection, and a molding protrusion is formed in an injection mold at a corresponding position on a boundary surface between the base material layer and the black layer, inside the base material layer.

13. The method of claim 12,
wherein in the forming a black layer, a notch corresponding to a shape of the molding protrusion is formed in the base material layer.

14. The method of claim 13,
wherein the notch is formed to have a thickness which is 5% to 10% of a thickness of the black layer.

15. The method of claim 10,
wherein in the forming a base material layer, the base material layer comprises 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, and 0.1 to 5 wt.-% of a solvent used for a coating material.

16. The method of claim 10,
wherein in the forming a black layer, the black layer comprises 80 to 90 wt.-% of a polycarbonate (PC) resin, 1 to 5 wt.-% of colored pigments, 1 to 3 wt.-% of a HALS (Hindered Amine Light Stabilizer), 1 to 3 wt.-% of a light stabilizer, 0.1 to 5 wt.-% of a solvent used for a coating material, and 0.0001 to 5 wt.-% of a light shielding agent.

17. The method of claim 10, further comprising:
forming a coating layer on another surface of the base material layer after the forming a black layer,
wherein the elastomer layer is formed to surround the black layer, the base material layer, and the coating layer.

18. The method of claim 17,
wherein in the forming a coating layer, the coating layer comprises 30 to 50 wt.-% of a polyhedral oligomeric silsesquioxane (POSS), 20 to 30 wt.-% of an epoxy-based oligomer, 10 to 20 wt.-% of an epoxy-based monomer, 5 to 30 wt.-% of nano-silica, 5 to 10 wt.-% of a silicon oil, 1 to 5 wt.-% of a metal oxide, 1 to 3 wt.-% of an ultraviolet absorber, 1 to 3 wt.-% of an ultraviolet scattering agent, 1 to 5 wt.-% of a light stabilizer, and 1 to 5 wt.-% of other additives.
